(19) United States
(12) Patent Application Publication
(10) Pub. No.: US 2023/0038232 A1
(43) Pub. Date: Feb. 9, 2023

(54) Floor Finish Removal Pad Assembly and Method of Removing Floor Finish

(71) Applicant: 3M INNOVATIVE PROPERTIES COMPANY, St. Paul, MN (US)

(72) Inventors: Lijun Zu, Woodbury, MN (US); Joseph B. Eckel, Vadnais Heights, MN (US); Aaron K. Nienaber, Lake Elmo, MN (US); Jaime M. Manalo, Woodbury, MN (US); Yuyang Liu, St. Paul, MN (US); Thomas J. Nelson, Woodbury, MN (US)

(21) Appl. No.: 17/758,084

(22) PCT Filed: Dec. 21, 2020
(86) PCT No.: PCT/IB2020/062302

§ 371 Date: Jun. 28, 2022

Related U.S. Application Data
(60) Provisional application No. 62/954,964, filed on Dec. 30, 2019.

(51) Int. Cl. B24B 7/18; B24D 3/00; C09K 3/14

(52) U.S. Cl. CPC B24B 7/186; B24D 3/00; C09K 3/1409

(57) ABSTRACT

Floor finish removal pad assemblies are described. Methods of removing floor finish with floor finish removal pad assemblies are described. In particular, the floor finish removal pad assemblies include a compressible backing pad and a plurality of discontinuously arranged non-rigid coated abrasives or a single discontinuously patterned substantially coextensive coated abrasive. Methods using such floor finish removal pad assemblies may remove floor finish effectively even without the use of chemical strippers.

### BACKGROUND

Protective floor finish scratches, scuffs, and wears as it is exposed to the environment and foot and commercial building traffic (e.g., carts). In order to reapply floor finish, the floor finish must be removed to expose the bare substrate underneath. Caustic chemicals are conventionally required to soften the hard finish so that it can be removed through abrasion.

### SUMMARY

In one aspect, the present description relates to a floor finish removal pad assembly. In particular, the floor finish removal pad assembly includes a compressible backing pad having a first major surface and a second major surface, and a plurality of discontinuously arranged, non-rigid coated abrasive articles attached to the first major surface of the compressible backing pad.

In another aspect, the present description relates to a method of removing floor finish. In particular, the method of removing floor finish includes contacting a plurality of discontinuously arranged, non-rigid coated abrasive articles attached to a major surface of a compressible backing pad with a coated hard floor surface and optionally repeating the step of contacting. The step of contacting is done in the absence of an effective amount of chemical strippers.

In yet another aspect, the present description relates to a floor finish removal pad assembly. In particular the floor finish removal pad assembly includes a compressible backing pad having a first major surface and a second major surface, and a discontinuously patterned, non-rigid coated abrasive article substantially coextensive with the compressive backing pad and attached to the first major surface of the compressible backing pad.

### BRIEF DESCRIPTION OF THE DRAWINGS

FIG. 1 is a bottom plan view of an exemplary floor finish removal pad assembly including several exemplary shapes of coated abrasive articles.

FIG. 2 is a schematic perspective view of exemplary abrasive grain shapes.

FIG. 3 is a schematic elevation view of an exemplary system to remove floor finish using a floor finish removal pad assembly.

FIG. 4 is a schematic plan view of an exemplary abrasive pattern.

### DETAILED DESCRIPTION

Floor stripping, in the area of floor care, refers to completely removing old wax, finish, soil, and debris found on the floor. It is known that floor stripping is one of the most time-consuming and labor-intensive tasks in the maintenance and care of floors, or even throughout all of the professional cleaning industry. In general, applying a wax or a floor finish to a floor surface substrate helps keep the floor looking attractive, glossy, and free from scratches and stains. Typically, these finishes or waxes are applied in multiple layers or coats. However, over time, and especially with heavy foot or other traffic, these layers wear down, become embedded with dirt or debris, and cannot be cleaned or restored through regular conventional maintenance. In these cases the floor finish or wax must be completely removed in order for a new finish coating to be applied.

A conventional floor stripping process includes four discrete steps. First, floor finish stripping chemicals are applied on the floor surface and left to dwell for approximately ten minutes. Next, a floor stripping pad is used to abrade the loosened and/or softened floor finish. Third, the stripping solution, now contaminated with dirt and floor finish particulates, must be removed from the floor. Finally, the bare floor must be cleaned and dried before reapplying any floor finish.

Because of the messy, smelly, and potentially dangerous conventional process, there has been a desire to use chemical-free floor stripping methods. However, current methods take multiple passes to remove even a single layer of floor coating. Considering that most floor coatings recommend multiple (e.g., two or four) coats, presently available chemical-free stripping solutions are not practical in light of the additional labor cost required.

Floor finish removal pad assemblies described herein are surprisingly effective at removing layers of floor finish without using chemical floor strippers. In some embodiments, floor finish removal pad assemblies take advantage of specifically shaped and aligned abrasive grains. In some embodiments, floor finish removal pad assemblies take advantage of being non-rigid coated abrasive articles placed discontinuously on a compressible backing pad. All floor surfaces have some degree of unevenness, and such compressibility and non-rigidity may help these assemblies reach the low points of an uneven floor and remove floor finish coating thereon.

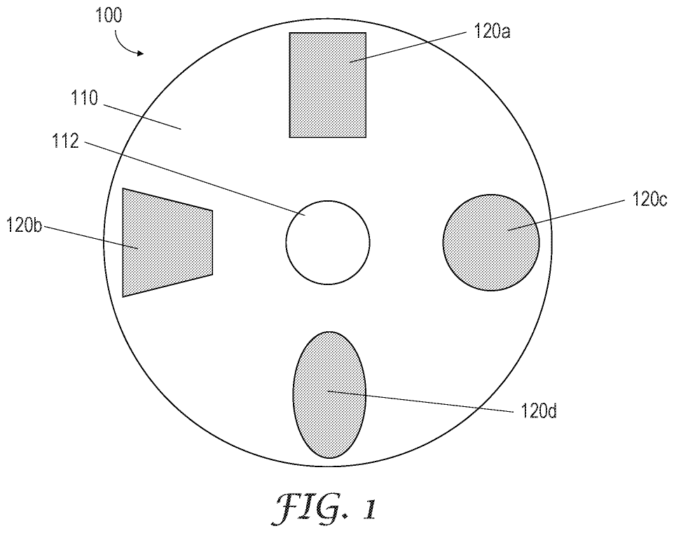

FIG. 1 is a bottom plan view of an exemplary floor finish removal pad assembly including several exemplary shapes of coated abrasive articles. Floor finish removal pad assembly 100 includes compressible backing pad 110, optional mounting hole 112, and exemplary discontinuously arranged coated abrasive articles 120a, 120b, 120c, and 120d.

Floor finish removal pad 100 may be any overall shape and size. In some embodiments, floor finish removal pad 100 may be round or disc-like if intended to be mountable on a rotating machine. In some embodiments, floor finish removal pad 100 may be rectangular or square if intended to be mountable on a square sander or an orbital sander.

Compressible backing pad 110 likewise may be any suitable shape, size, and thickness. In some embodiments, compressible backing pad may be any suitable thickness between, for example 0.25 and 10 cm. A thickness of one inch is common (2.54 cm). In some embodiments, the compressible backing pad may have a standard size and shape for mounting on existing floor cleaning and treatment equipment. For example, 20 inch (50.8 cm) floor pads are common, but sizes from 10 inches (25.4 cm) to 24 inches (60.96 cm) in diameter may be suitable for these applications.

Compressible backing pad 110 may be formed from any suitable material or materials. In some embodiments, compressible backing pad 110 is a urethane foam rubber or a natural latex foam rubber. In some embodiments, compressible backing pad 110 is an open-celled ethylene-vinyl acetate. Any compressible natural or polymeric material or blends thereof may be used. In some embodiments, compressible backing pad is a lofty non-woven pad. In these embodiments, the material used for the particular nonwoven fibers need not be itself compressible, but the lofty pad may be configured to be compressible as the fibers may flex under stress. The fibers may include natural and synthetic fibers. In some embodiments, the fibers may be or include natural fiber (e.g., vegetable fibers such as hemp, jute, and the like; animal hair fibers, such as hog's hair), a polyamide (e.g., a nylon), a polyester (e.g., polyethylene terephthalate or polyethylene isophthalate), rayon, polyethylene, polypropylene, a synthetic fiber, or a combination thereof. Synthetic fibers include polymers derived from natural sources, such as polylactic acid derived from corn. The fibers may be adhered to each other at their joints of mutual contact by a binder and/or by being melt-bonded.

Compressible backing pad 110 includes optional mounting hole 112. Optional mounting hole may be any suitable size or shape, and can be adapted or designed to cause floor finish removal pad assembly 100 to be usable or attachable to any desired floor treatment or maintenance machine.

Discontinuously arranged coated abrasive articles 120a, 120b, 120c, and 120d may be any suitable shape and size, although in many embodiments it is desirable for such coated abrasive articles to fit completely within the area of compressible backing pad 110 when attached. As can be seen from the variety of shapes represented 120a, 120b, 120c, and 120d, there are many possible suitable configurations. In some embodiments, the coated abrasive articles are all the same shape; in some embodiments, the coated abrasive articles are different shapes. In some embodiments, the coated abrasive articles are the same size or area; in some embodiments, the coated abrasive articles are different sizes or areas. Suitable shapes include circles, ovals, ellipses, polygons, squares, rectangles, trapezoids, diamonds, rhombuses, and the like. Irregular, curved, and other shapes are also possible and may be suitable for certain applications. The coated abrasive articles are non-rigid, meaning they have at least some degree of freedom to recoverably bend without cracking or fracturing. In some embodiments, the coated abrasive articles may include a cloth or fabric backing, or a thin or flexible polymeric backing. In some embodiments, the coated abrasive articles may include a nonwoven or foam backing. In some embodiments, the coated abrasive articles may be removably attachable to the compressible backing pad, and may include adhesives or hook and loop (or other physical interlock) mechanisms for mounting.

The coated abrasive articles are covered with or at least include a plurality of abrasive grains. In some embodiments, the plurality of abrasive grains includes one type of abrasive material. In some embodiments, the plurality of abrasive grains includes a plurality or blend of abrasive materials. In some embodiments, the plurality of abrasive grains includes just one of substantially the same shape abrasive grain. In some embodiments, the plurality of abrasive grain includes multiple shapes of abrasive grains. The abrasive grains can be any of the abrasive particle materials described herein, such as aluminum oxide, ceramic aluminum oxide, heat-treated aluminum oxide, silicon carbide, co-fused alumina-zirconia, diamond, ceria, titanium diboride, cubic boron nitride, boron carbide, garnet, flint, emery, sol-gel derived abrasive particles, novaculite, pumice, rouge, sand, corundum, sandstone, tripoli, powdered feldspar, staurolite, ceramic iron oxide, glass powder, steel particles, and blends thereof. The abrasive coating can also include resins. Exemplary resins suitable for use include melamine resin, polyester resin such as the condensation product of maleic and phthalic anhydrides and propylene glycol, synthetic polymers such as styrene-butadiene (SBR) copolymers, carboxylated-SBR copolymers, phenol-aldehyde resins, polyesters, polyamides, polyureas, polyvinylidene chloride, polyvinyl chloride, acrylic acid-methylmethacrylate copolymers, acetal copolymers, polyurethanes, and mixtures and cross-linked versions thereof.

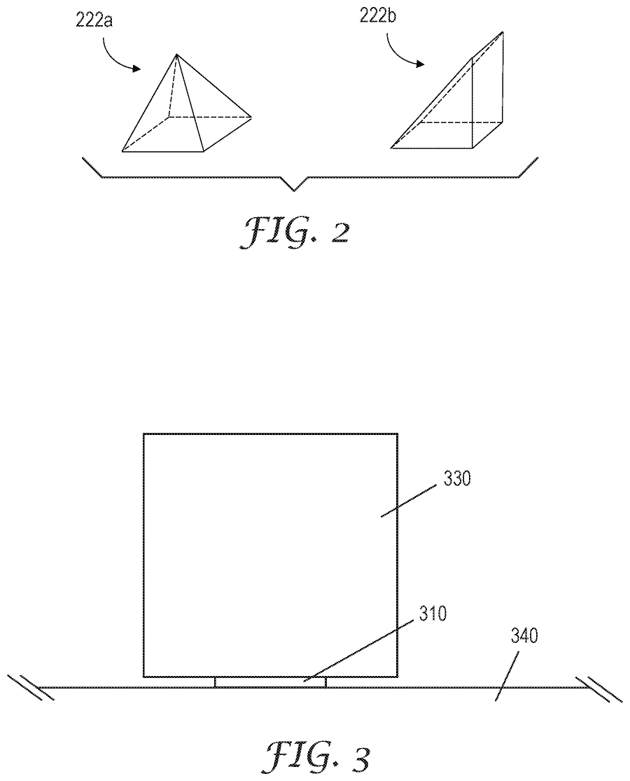

Shaped abrasive grains may be particularly useful in certain embodiments. Shaped abrasive grains may be molded abrasive grains that include shapes not found in essentially randomized conventionally sourced abrasives. Shaped abrasive grains may also be more uniform in shape. Methods of making shaped abrasive grains are known and are described, for example, in U.S. Pat. No. 8,142,531B2 (Adefris et al.). Suitable shaped abrasive grains may be any suitable shape (discussed in more detail in conjunction with FIG. 2) and any suitable size. In some embodiments, average or characteristic dimensions of the abrasive grains (whether shaped or not) may be between 0.01 and 0.1 mm, between 0.1 and 0.5 mm, between 0.5 and 1 mm, or between 1 mm and 5 mm. In some embodiments, the plurality of abrasive grains may include a blend of sizes. Abrasive grains or abrasive grains mixed with or in any other components to create an abrasive slurry may be coated onto the backing by any suitable method, including spray coating or roll coating. Lubricants or other additives may be incorporated or included.

In some embodiments, any of the abrasive grains described in conjunction with the discontinuous non-rigid coated abrasive articles may be present on any other part of the floor finish removal pad assembly, such as on the compressible backing pad.

In some embodiments, a single coated abrasive article including a backing is coextensive or substantially coextensive with the compressible backing pad. The backing of the single coated abrasive article may be patterned to create areas of abrasives adjacent to areas without abrasives. As for any of the discontinuous coated abrasive articles described above, any suitable abrasive or combination of abrasives may be used.

FIG. 2 is a schematic perspective view of exemplary abrasive grain shapes. Equilateral triangle abrasive grain shape 222a has faces which approximate an equilateral triangle. Right triangle abrasive grain shape 222b has faces which approximate a right triangle. Shapes such as those depicted in FIG. 2 may be particularly suitable for specific types of floor finish, or may be generally applicable to a variety of floor finish, and the shape may be selected based on the application and desired performance. In some embodiments, other shapes or modifications of the shapes represented herein may be used. For example, the sidewall length or angle may be modified.

FIG. 3 is a schematic elevation view of an exemplary system to remove floor finish using a floor finish removal pad assembly. Floor device 330 incorporates floor finish removal pad assembly 310 in order to remove a floor finish from coated floor 340. Floor device 330 may be an autoscrubber. In some embodiments, floor device 330 may be an orbital sander or a square sander. Floor device 330 is configured to aid in contacting floor finish removal pad assembly 310 against coated floor 340. In some embodiments, contacting floor finish removal pad assembly 310 against coated floor 340 includes rotating the floor finish removal pad assembly. Coated floor 340 may be any coated hard surface, including vinyl composition tile (VCT), solid vinyl tile, a stone floor, or any other suitable natural or manufactured floor surface. In FIG. 3, coated floor 340 is indicated with break lines to show it can be of arbitrarily large or small dimensions. Coated floor may also include any wax or floor coating or protector, with any number of coats (though typically less than ten). In some embodiments, contacting the floor finish removal pad assembly against the coated floor includes translating the floor finish removal pad assembly laterally in relation to the coated floor. In some embodiments, contacting the floor finish removal pad assembly against the coated floor is done in the absence of chemical strippers. In some embodiments, contacting the floor finish removal pad assembly against the coated floor is done in the absence of water. In some embodiments, the contacting step is optionally repeated. In some embodiments, removing a 25-micrometer thick coat of floor finish requires less than 10 steps of contacting.

### EXAMPLES

Floor finish removal pad assembly samples were made by coating abrasives on a film backing. The samples were tested for cut and finish removal. Unless otherwise noted, all parts, percentages, ratios, etc. in the Examples and the rest of the specification are by weight. Unless stated otherwise, all other reagents were obtained, or are available from chemical vendors such as Sigma-Aldrich Company, St. Louis, Mo., or may be synthesized by known methods.

TABLE 1
Abbreviations for materials and reagents used in the Examples.

| | |
|---|---|
| PF1 | RESOLE resin (75 wt. % in water), a phenol: formaldehyde (molar ratio of |
| | 1:1.5to 1:2.1) condensate catalyzed by 1 to 5% metal hydroxide. Obtained from |
| | Georgia Pacific, Atlanta, GA. |
| FILI | Calcium carbonate, 13 micrometer average particle size. Obtained under trade |
| | designation “Q325” form J.M. Huber Coporation, Altanta, Ga. |
| FIL2 | Calcium silicate obtained under the trade designation M400 |
| | WOLLASTOCOAT. Obtained from NYCO,Willsboro, NY. |
| FIL3 | Hydrophilic amorphous fumed silica obtained under the trade |
| | designation CAB-O-SIL M-5 from Cabot Corporation, Alpharetta, GA. |
| FIL4 | Cryolite obtained under the trade designation CRYOLITE RTN-C. Obtained |
| | from FREEBEE A'S, Ullerslev, Denmark. |
| LATEX | A nitrile latex available under trade designation “HYCAR 1581” from Noveon, |
| | Cleveland, OH. |
| RIO | Red iron oxide pigment obtained under the trade designation KROMA RO- |
| | 3097. Obtained from Elementis, East Saint Louis, IL. |
| MINI | Shaped abrasive particles were prepared according to the disclosure of U. S. |
| | Pat. No. 8,142,53 l(Adefris et al.). The shaped abrasive particles were prepared |
| | by molding alumina sol gel in right triangle-shaped polypropylene mold |
| | cavities. The fired shaped abrasive particles were about 1 mm (side length) x |
| | 0.25mm thick. |
| MIN2 | Shaped abrasive particles were prepared according to the disclosure of U. S. |
| | Pat. No. 8,142,53 l(Adefris et al.). The shaped abrasive particles were prepared |
| | by molding alumina sol gel in equilateral triangle-shaped olypropylene mold |
| | cavities. The fired shaped abrasive particles were about 1 mm (side length) x |
| | 0.25mm thick. |
| MIN3 | ANSI grade 40 aluminum oxide, obtained from Washington Mills |
| | Electro Minerals Corporation, Niagara Falls, New York. |
| MIN4 | ANSI grade 80 aluminum oxide, obtained from Washington Mills |
| | Electro Minerals Corporation, Niagara Falls, New York. |
| MIN5 | Formed abrasive particles were prepared according to the disclosure of U.S. Pat. |
| | No. 8,142,531 (Adefris et al.). The formed abrasive particles were prepared by |
| | molding alumina sol gel in equilateral triangle-shaped polypropylene mold |
| | cavities. The draft angle between the sidewall and bottom of the mold was 98 |
| | degrees. After drying and firing, the resulting formed abrasive particles were |
| | about 600pm (side length) x 0.25 millimeter (thickness). The formed abrasive |
| | particles made as described above are used, for example, in 3M Cubitron II |
| | Hookit Clean Sanding abrasive disc 737U, grade 320+, available from 3M |
| | Company (St. Paul, Minnesota, USA). |
| MAKE1 | PF1 was catalyzed with 2.5 percent by weight potassium hydroxide. |
| SIZEI | The size coat composition was prepared by charging a 3 liter (L) plastic container |
| | with 431.5 g of PF1, 227.5 g of FIL2, 227.5 g of FIL4 and 17 g of RIO, |
| | mechanically mixing and then diluting to a total weight of 1 kilogram with water. |
| SIZE2 | FILI (450g) and 15 g of RIO were mechanically stirred into 285 g of PF1. The |
| | mixture was diluted to 1 kilogram with water. |
| SATURANTI | PF1 (900g) and 100g of LATEX were mechanically stirred until mixture was |
| | uniformly blended. |
| BACK1 | A backing material (100% polyester 4/1 sateen fabric made from open end spun |
| | yams weight about 300-400 grams per square meter) obtained under |
| | “POWERSTRAIT” from Milliken & Company, Sparta, SC., was treated with |
| | SATURANTI bringing the weight to 416 grams per square meter and was |
| | subsequently backsized with SIZE2 bringing weight to about 516 grams per |
| | square meter. This is called X-weight Polyester backing, which was converted |
| | to 4-inch (10cm) width. |
| B7 | Phenolic resin obtained as PREFERE 80 5077A from Arclin, Mississauga, |
| | Ontario, Canada |
| GEO | Anti-foam agent, obtained as GEO FM LTX from GEO Specialty Chemicals, |
| | Ambler, Pennsylvania |
| uo | Solvent free aliphatic polycarbonate polyurethane Alberdingk U6150 from |
| | ALBERDINGK BOLEY INC Greensboro, NC |
| SIC | silicon carbide, black, grade P1500, obtained from GNP Ceramics LLC, |
| | Clarence Center, New York |
| DI | Ethoxylated nonionic surfactant, obtained as DYNOL 604 from Air Products |
| | and Chemicals Inc., Allentown, Pennsylvania |
| COL | Carbon black pigment, obtained as C-SERIES BLACK 7 LCD4115 from Sun |
| | Chemical Corporation, Cincinnati, Ohio |
| FIL5 | Silicon Dioxide Cabosil M5 from ET HORN CO, La Mirada California. |
| ANT | Synthetic Paraffin MP22 obtained from Micro powders Inc, Tarrytown, New |
| | York |
| AP180 | Fused and fired Aluminum oxide particles of size 180, produced by Triebacher, |
| | Austria |

### Example 1

MAKE1 was continuously coated at a weight of 24 grains per 4″×6″ (10×15 cm) area by means of a notch bar onto BACK1.

MIN1 was coated onto the continuously moving BACK1 by means of an electrostatic coater at a total mineral weight of 60 grains per 4″×6″ (10×15 cm) area. A second mineral MIN4 was also applied by means of an electrostatic coater at a weight of 20 grains per 4″×6″ (10×15 cm) area.

Material was converted to lengths of approximately 40 inches long and placed in a batch oven. Oven was operated for 30 minutes at 175 F, 30 minutes at 195 F, and 70 minutes at 210 F.

Material was removed from a batch oven and pass through a roll coater to apply SIZE1 at a coverage rate of 483 grams per square meter with a 75 cm paint roller and resultant product was cured at 90° C. for 60 minutes and then at 102° C. for 8 hours more.

### Example 2

The sample made in Example 1 was repeated, except that MIN2 used in alternative to MINI.

### Example 3

The sample made in Example 1 was repeated except that MIN3 was used in alternative to MIN1.

### Example 4

A-Preparation of Laminated Loop Backing

| | |
|---|---|
| NET MESH | Net Mesh GR150 H100 available from SitiP, S.p.A., Cene, |
| | Italy. |
| BOSTIK | PE85-60 30610536 Hot melt web 48 inches wide (72 gsm) |
| | available from Bostik, Inc., Wauwatosa, Wisconsin. |

The NET MESH was laminated to one layer of 72 grams per square meter of BOSTIK using an iron press for about two seconds contact time, this way creating a continuous film on the loop backing.

B-Phenolic Resin preparation

The components of the phenolic resins used to prepare the abrasive articles described herein are listed in Table 2.

TABLE 2
Components and percentages of Phenolic Resin mix.

| Ingredients | Wt. % |
|---|---|
| B7 | 55-75 |
| uo | 1-10 |
| D1 | 0.005-0.02) |
| GEO | 0.0005-0.003 |
| FIL2 | 10-20 |
| SIC | 1-10 |
| COL | 0.1-0.5 |
| FIL5 | 1-5 |
| ANT | 1-10 |

A curable composition was prepared, under high speed dispersion, using a high shear blade between 600 rpm to 900 rpm, until a homogeneous mix was obtained, by blending B7 with U0, then under shear adding D1, GEO, COL, SIC, FIL2, ANT and slowly adding FIL5.

C-Stencil printing process

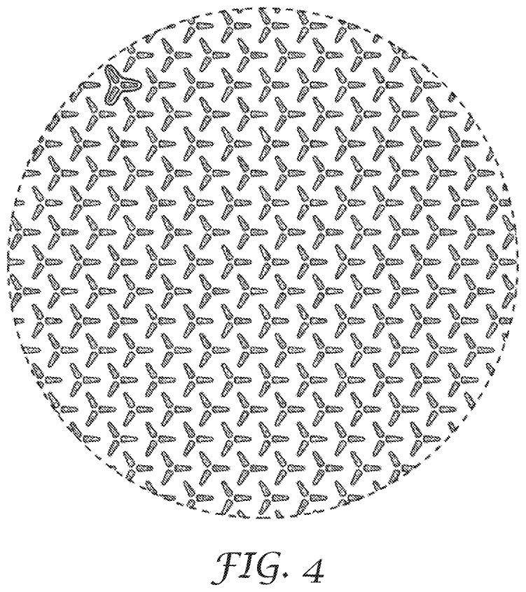

Using a patterned 3 mil polyester stencil (patterned as shown in FIG. 4) placed over the continuous film on the A-Laminated Loop Backing, the curable composition B-Phenolic Resin was stencil printed by bringing the backing and the stencil in contact, applying the curable composition to the side of the stencil opposite the backing, forcing the curable composition through the screen/stencil with a blading mechanism, then separating the stencil and backing leaving a coating of the curable composition on the backing, the amount of curable composition coated was 100 gsm, having a film thickness of 100 microns. Then while the curable composition was still wet, 50 gsm blend of 70% AP180 and 30% MIN5 were electrostatically coated (Spellman SL 150). The entire construction was then thermally pre-cured in a batch oven at 80° C. for 30 minutes and final cured in a batch oven at 103° C. for four hours. During this final stage the curable composition was cured and the BOSTIK melted, wicking down the threads and screen of the loop backing, reopening a number of the original holes of the backing. In this instance, a minimum 90% of original holes were reopened.

Comparative Example 13M High Productivity Pad 7300 (available from 3M Company, St. Paul, Minn.)

Comparative Example 23M Black Stripper PAD 7200 (available from 3M Company, St. Paul, Minn.)

Comparative Example 3 SCOTCH-BRITE Surface Preparation Pad Plus (available from 3M Company, St. Paul, Minn.)

### TEST RESULTS

### 1. Schiefer Cut Test

Schiefer cut testing was performed to evaluate the relative abrasiveness of the articles in this invention. The test was performed in a generally similar manner as described in U.S. Pat. No. 5,626,512 (Palaikis et al). EXAMPLEs 1-3 were laminated with a layer of hook materials (Aplix 220 hook), then were cut into a circular pad (8.25 cm in diameter). 3M 96 scouring pad (available from 3M Company, St. Paul, Minn.) was cut into a circular shape with the same size. The hook side of the article was attached to the 3M 96 scouring pad, then the whole assembly was secured to the drive plate of the Schiefer Abrasion Tester (available from Frasier Precision Company of Gaithersburg, Md.). The workpieces were all approximately 10.16 cm in diameter and about 0.317 cm thick. The initial dry weight of each workpiece was recorded and the workpiece was secured to the lower turntable of the test machine using double sided foam tape. Testing was conducted under a load of 2.26 kg for 2,000 revolutions in total with water applied to the surface of the acrylic disc at a rate of 40-60 drops/minute. The test was stopped every 500 revolutions. The workpiece was dried and weighed. The weight loss of the acrylic disc during the test was given as the result (reported as grams) in Table 3. Example that shows higher weight loss has higher cut rate.

TABLE 3
Schiefer Cut Test Results: weight loss in gram after every 500 cycles

| | | | | |
|---|---|---|---|---|
| .Cycles | 500 | 1000 | 1500 | 2000 |
| Example No.. | | | | |
| Example 1 | 1.68 | 3.27 | 4.86 | 6.41 |
| Example 2 | 1.36 | 2.72 | 4.04 | 5.33 |
| Example 3 | 0.85 | 1.68 | 2.52 | 3.30 |
| Example 4 | 1.26 | 2.50 | 3.74 | 4.96 |
| Comparative Example 1 | 0.61 | 1.16 | 1.70 | 2.22 |
| Comparative Example 2 | 0.24 | 0.47 | 0.71 | 0.93 |
| Comparative Example 3 | 0.29 | 0.56 | 0.82 | 1.06 |

2. Floor Finish Removal Test

A vinyl composition tile (VCT) floor test area was first stripped, then coated with 1 layer of Signature floor finish (available from Sealed Air, Charlotte, N.C., 28273) at a rate of 2000 sq. ft per gallon, and drew 5 marker lines on each tile after drying, then coated 4 layer of Signature floor finish on top of maker lines and allowed to cure 7 days before testing. Examples 1˜4 were laminated with a layer of hook materials (Aplix 220 hook), then were cut into 3″×9″ (7.6×23 cm) strips and the hook side of 6 strips were attached to the 14″×20″ 3M Red Buffer floor pad in 3 rows, and the whole assembly was mounted on a 14″×20″ (35.6×51 cm) Square Scrub machine (EBG-20/C PIVOT from Square Scrub). The Square Scrub machine was moved back and forth on the tested tile. The number of passes were counted until 95% of the maker lines were removed. Back and forth were counted as 2 passes. Table 4 shows the testing results. Examples that needed less number of passes to remove 4 layers of Signature floor finish are more efficient.

TABLE 4
Floor Finish Removal Test Results

| | No. of passes to remove 4 |
|---|---|
| Example No. | layers of floor finish |
| Example 1 | 3 |
| Example 2 | 4 |
| Example 3 | 10 |
| Example 4 | 3 |
| Comparative Example 1 | 16 |
| Comparative Example 2 | 30 |
| Comparative Example 3 | 40 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modifications and variations of the concepts herein disclosed may be resorted to by those of ordinary skill in the art, and that such modifications and variations are considered to be within the scope of embodiments of the present invention.

What is claimed is:

1. A floor finish removal pad assembly, comprising:
a compressible backing pad having a first major surface and a second major surface; and
a plurality of discontinuously arranged, non-rigid coated abrasive articles attached to the first major surface of the compressible backing pad.

2. The floor finish removal pad of claim 1, where in plurality of discontinuously arranged, non-rigid coated abrasive articles are removably attached to the first major surface of the compressible backing pad.

3. The floor finish removal pad assembly of claim 1, wherein the coated abrasive articles include aluminum oxide grains.

4. The floor finish removal pad assembly of claim 1, wherein the coated abrasive articles include equilateral triangle shaped grains.

5. The floor finish removal pad assembly of claim 1, wherein the coated abrasive articles include right triangle shaped grains.

6. The floor finish removal pad assembly of claim 1, wherein the compressible backing pad is a lofty nonwoven pad.

7. The floor finish removal pad assembly of claim 1, wherein the compressible backing pad is a foam pad.

8. The floor finish removal pad assembly of claim 1, wherein the compressible backing pad includes abrasive grains.

9. The floor finish removal pad assembly of claim 1, wherein the coated abrasive articles include a lubricant.

10. A method of removing floor finish, comprising:
contacting a plurality of discontinuously arranged, non-rigid coated abrasive articles attached to a major surface of a compressible backing pad with a coated hard floor surface; and
optionally repeating the step of contacting;
wherein the step of contacting is done in the absence of an effective amount of chemical strippers.

11. The method of claim 10, wherein the step of contacting is done also in the absence of water.

12. The method of claim 10, wherein removing 25 micrometer thick coats of acrylic floor finish requires fewer than ten steps of contacting.

13. The method of claim 10, wherein, prior to the step of contacting, the method includes attaching the compressible backing pad to a scrubber or sander.

14. The method of claim 13, wherein the compressible backing pad is attached to an autoscrubber.

15. The method of claim 13, wherein the compressible backing pad is attached to an orbital sander.

16. A floor finish removal pad assembly, comprising:
a compressible backing pad having a first major surface and a second major surface; and
a discontinuously patterned, non-rigid coated abrasive article substantially coextensive with the compressive backing pad and attached to the first major surface of the compressible backing pad.

17. The floor finish removal pad assembly of claim 16, wherein the coated abrasive article include aluminum oxide grains.

18. The floor finish removal pad assembly of claim 16, wherein the coated abrasive article include equilateral triangle shaped grains.

19. The floor finish removal pad assembly of claim 16, wherein the coated abrasive article include right triangle shaped grains.

20. The floor finish removal pad assembly of claim 16, wherein the compressible backing pad is a lofty nonwoven pad or a foam pad.
